(19) United States
(12) Patent Application Publication
(10) Pub. No.: US 2008/0155273 A1
(43) Pub. Date: Jun. 26, 2008

(54) Automatic Bus Encryption And Decryption

(75) Inventor: Gregory R. Conti, Saint Paul (FR)

Correspondence Address: TEXAS INSTRUMENTS INCORPORATED, P O BOX 655474, M/S 3999, DALLAS, TX, 75265, US

(73) Assignee: TEXAS INSTRUMENTS, INC., Dallas, TX (US)

(21) Appl. No.: 11/619,738

(22) Filed: Jan. 4, 2007

(30) Foreign Application Priority Data
Dec. 21, 2006 (EP) 06292034.3

(51) Int. Cl. G06F 12/14

(52) U.S. Cl. 713/190; 711/E12.092

(57) ABSTRACT

A system, method, and logic are disclosed for automatic hardware bus encryption/decryption. The logic receives a memory access request comprising a physical address of a memory location from a processor. The logic translates the physical address, and uses the translated physical address and a seed value in a pseudo random number generator to produce an output value. The logic then uses the output value to non-deterministically select an encryption key from a plurality of encryption keys. If the memory access request is a read operation, the logic uses the selected key to decrypt the contents of the memory location; and provides the decrypted contents to the processor. If the memory access request is a write operation, the logic uses the selected key to encrypt a value comprised in the memory access request; and writes the encrypted value in the memory location.

### CROSS-REFERENCE TO RELATED APPLICATION

The present application claims priority to EP Application No. 06292034.3, filed on Dec. 21, 2006, hereby incorporated herein by reference.

### BACKGROUND

The number and size of software applications and services available on mobile electronic devices such as personal digital assistants (PDAs) and digital cellular telephones is increasing rapidly. Many of these applications need to be protected to reduce the likelihood of attacks by malicious programs (e.g., virus programs), and to prevent access to sensitive data. Mobile equipment manufacturers have introduced mobile devices that include processing systems incorporating hardware-based security mechanisms that may be used to protect these applications and the secure data if they are in on-chip memory. An example of one such system may be found in U.S. Patent Publication No. 2003/0140245, entitled “Secure Mode for Processors Supporting MMU and Interrupts.” Examples of additional hardware-based security monitoring components that may be added to the processing systems used in mobile electronic devices to further reduce the vulnerability to attacks may be found in U.S. patent application Ser. No. 10/961,756, entitled “System and Method for Secure Mode for Processors and Memories on Multiple Semiconductor Dies Within a Single Semiconductor Package,” U.S. patent application Ser. No. 10/961,755, entitled “Method and System of Ensuring Integrity of a Secure Mode Entry Sequence,” U.S. patent application Ser. No. 10/961,344, entitled “System and Method of Identifying and Preventing Security Violations Within a Computing System,” U.S. patent application Ser. No. 10/961,748, entitled “Method and System of Verifying Proper Execution of a Secure Mode Entry Sequence,” and European Patent Application EP 04292405.0, entitled “Method and System for Detecting a Security Violation Using an Error Correction Code,” all of which are hereby incorporated by reference.

However, the rapid expansion in the size and availability of applications is creating an increasing reliance on the use of memories external to the chip in these processing systems (e.g., flash memory, hard disks, and external RAM) both for storing the applications and sensitive data, and for use during execution. Thus, protection of the application code and sensitive data while stored in external storage memories, and during transition to and from these memories and/or external RAM during execution is desirable.

### SUMMARY

Accordingly, there are disclosed herein systems and methods for automatically encrypting/decrypting instructions fetched and data transferred to and from the processor and the external memories. Embodiments provide for storing the applications and data requiring protection in an encrypted format in external storage memory. The instructions comprising an encrypted application and/or the encrypted data are decrypted when an instruction or a data word is fetched for execution, and are re-encrypted when written to an external memory.

### BRIEF DESCRIPTION OF THE DRAWINGS

For a detailed description of exemplary embodiments of the invention, reference will now be made to the accompanying drawings in which:

FIGS. 1 and 2 show systems in accordance with one or more embodiments.

FIGS. 3, 4, 5A and 5B illustrate hardware bus encryption subsystems in accordance with one or more embodiments.

FIG. 6 shows a flow diagram of a method for a hardware bus encryption in accordance with one or more embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Inasmuch as the systems and methods described herein were developed in the context of a mobile system, the description herein is based on a mobile computing environment. However, the discussion of the various systems and methods in relation to a mobile computing environment should not be construed as a limitation as to the applicability of the systems and methods described herein to only mobile computing environments. One of ordinary skill in the art will appreciate that these systems and methods may also be implemented in other computing environments such as desktop computers, laptop computers, network servers, mainframe computers, television set-top boxes, and embedded systems.

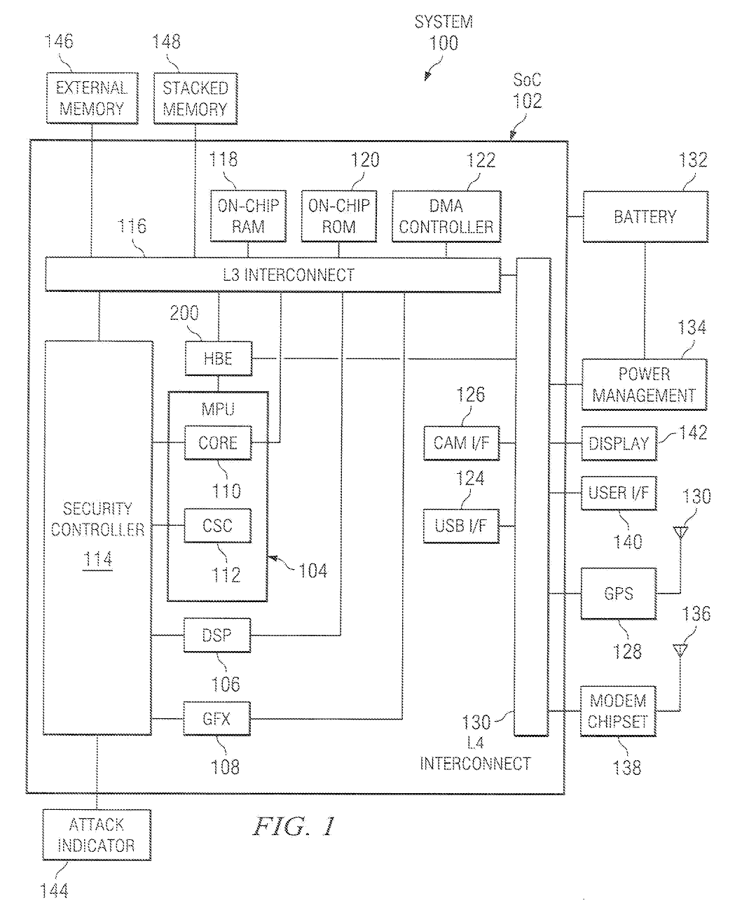

FIG. 1 shows a system 100 constructed in accordance with one or more embodiments of the invention. In accordance with at least some embodiments, the system 100 may be a mobile device such as a cellular telephone, personal digital assistant (PDA), text messaging system, and/or a device that combines the functionality of a messaging system, personal digital assistant and a cellular telephone.

The system 100 includes a multiprocessing unit (MPU) 104 coupled to various other system components by way of data and instruction busses and security firewalls (e.g., L3 interconnect 116, and L4 interconnect 130). The MPU 104 includes a processor core (core) 110 that executes programs. In some embodiments, the core 110 has a pipelined architecture. The MPU 104 further includes a core security controller (CSC) 112, which aids the MPU 104 in entering a secure mode for execution of secure programs on the core 110. The core security controller 112 may also monitor operation during secure mode to ensure secure operation, and during non-secure mode to prevent access to secure components of the system 100. Each of the core security controllers (e.g., core security controller 112) is implemented as a hardware-based state machine that monitors system parameters of each of the respective processor cores (e.g., core 110). A core security controller allows the secure mode of operation to initiate such that a processor may execute secure programs from secure memory (e.g., from a secure address range of the on-chip memory) and access secure resources (e.g., control registers for secure channels of the direct memory access controller 122). For more detailed description of embodiments of a core security controller, including the secure mode of operation, the signals that may be monitored to make the decision as to whether to enter the secure mode, and a state diagram for operation, reference may be had to United States Patent Application Publication No. 2003/0140245A1, published Jul. 24, 2003, which is assigned to the same Assignee as the present specification, and which is incorporated by reference herein as if reproduced in full below. According to embodiments of the present disclosure, the MPU 104 may or may not be in secure mode.

The core 110 may be any processor suitable for integration into a system on a chip (SoC), such as the ARM 1136 series of processors. In other embodiments, the core 110 may be a processor that includes some or all of the functionality of the core security controller 112 as described herein, such as the ARM 1176 series of processors. The ARM 1136 and 1176 technology may be obtained from ARM Holdings plc of Cambridge, United Kingdom, and/or ARM, Inc. of Austin, Tex., USA.

The system 100 also includes a digital signal processor (DSP) 106 coupled to the MPU 104 by way of the L3 interconnect 116. The DSP 106 aids the MPU 104 by performing task-specific computations, such as graphics manipulation and speech processing. The DSP 106 may have its own core and its own core security controller (not specifically shown). A graphics accelerator (GFX) 108 may also couple both to the MPU 104 and the DSP 106 by way of the L3 interconnect 116. The graphics accelerator 108 performs necessary computations and translations of information to allow display of information, such as on display device 142. The graphics accelerator 108, like the MPU 104 and the DSP 106, may have its own core and its own core security controller (not specifically shown). As with the MPU 104, both the DSP 106 and the graphics accelerator 108 may each independently enter a secure mode to execute secure programs on their respective cores, though being in secure mode is not required with the present disclosure.

The system 100 also includes a direct memory access controller (DMA CTLR) 122 coupled to on-chip RAM 118, on-chip ROM 120, external memory 146, and stacked memory 148 by way of the L3 interconnect 116. The direct memory access controller 122 controls access to and from the on-chip memory and the external memory by any of the other system components such as, for example, the MPU 104, the DSP 106 and the graphics accelerator 108. The memory components may be any suitable memory, such as synchronous RAM, RAMBUS™-type RAM, programmable ROMs (PROMs), erasable programmable ROMs (EPROMs), and electrically erasable programmable ROMs (EEPROMs). The external memory 146 may also be mass storage memory such as Flash memory or a hard disk. The stacked memory 148 may be any suitable memory that is integrated within the same semiconductor package as system-on-a-chip (SoC) 102, but on a semiconductor die separate from the semiconductor die of the system-on-a-chip 102.

The system 100 also includes various interfaces and components coupled to the various subsystems of the SoC 102 by way of the L4 interconnect 130. The interfaces include a USB interface (USB I/F) 124 that allows the system 100 to couple to and communicate with external devices, a camera interface (CAM I/F) 126 which enables camera functionality for capturing digital images, and a user interface (User I/F) 140A, such as a keyboard, keypad, or touch panel, through which a user may input data and/or messages. The components include a modem chipset 138 coupled to an external antenna 136, a global positioning system (GPS) circuit 128 likewise coupled to an external antenna 130, and a power management unit 134 controlling a battery 132 that provides power to the various components of the system 100.

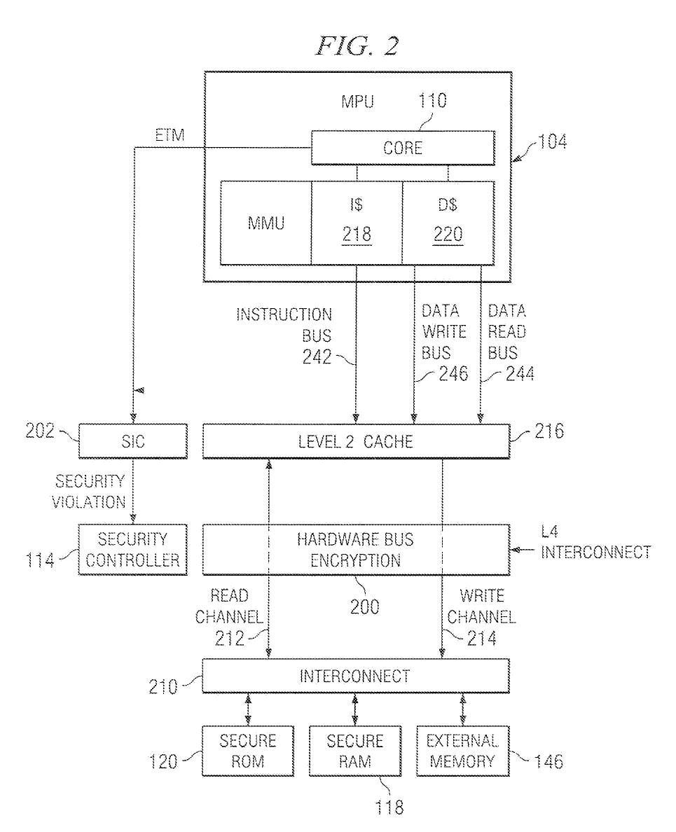

The system 100 also includes hardware bus encryption (“HBE”) logic 200 coupled to the MPU 104, the DMA controller 122, and external memory 146 by way of the L3 interconnect 116. In some embodiments, the HBE logic 200 could reside in the DMA controller 122, such as when the DMA controller is operating in a Scatter/Gather mode with its channel configuration stored in external memory (i.e., the register's configuration auto-updates the current DMA transfer). In a preferred embodiment, the HBE logic 122 may reside in the DMA controller 122, but such an architecture would add an intermediate step that slows down the transfer (e.g., could require 4 Kbyte buffer in internal RAM). The HBE logic 200, embodiments of which are described more detail in relation to FIGS. 2-5 below, may be programmed to encrypt and decrypt instructions and data of computer program code executing on the MPU 104. That is, the HBE logic 200 may be programmed to monitor instruction and data busses for memory accesses (i.e., reads and writes), looking for accesses to specified segments (i.e., address ranges) in external memory 146. These specified segments store data and instructions of the executing code that have been previously encrypted by the HBE logic 200. If the HBE logic 200 detects a read from one of the protected segments in external memory 146, the HBE logic 200 decrypts the values read from memory before the values are stored in the caches of the MPU 104. If the HBE logic 200 detects a write to one of the protected segments in external memory 146, the HBE logic encrypts the values to be written before the values are stored in external memory 146.

Many of the components illustrated in FIG. 1, while also available as individual integrated circuits, may be integrated or constructed onto a single semiconductor die. Thus, the MPU 104, digital signal processor 106, memory controller 122, along with some or all of the remaining components, may be integrated onto a single die, and thus may be integrated into the system 100 as a single packaged component. Having multiple devices integrated onto a single die, especially devices comprising an MPU 104 and on-chip memory (e.g., on-chip RAM 118 and on-chip ROM 120), is generally referred to as a system-on-a-chip (SoC) 102 or a megacell. While using a system-on-a-chip may be preferred, obtaining the benefits of the systems and methods as described herein does not require the use of a system-on-a-chip.

FIGS. 2-5 illustrate the functionality of embodiments of the HBE logic 200 in more detail. As is illustrated in FIG. 2, in the system 100, the core 110 of MPU 104 is coupled to level 1 cache including an instruction cache 218 and a data cache 220, and a level 2 cache 216. While the level 1 cache is shown as including separate instruction and data caches, and the level 2 cache is shown as a unified cache, the scope of this disclosure is not limited to the illustrated cache organization. Other cache organizations may be used.

The level 2 cache 216 is coupled to the instruction cache 218 by way of instruction bus 242, and to the data cache 220 by way of the data read bus 244 and the data write bus 246. The level 2 cache 216 is also coupled to the various memories of the system 100 (e.g., secure ROM 120, secure RAM 118, and external memory 146) by way of the interconnect 210, the read channel 212, and the write channel 214. The interconnect 210, the instruction busses, and the data busses are included in the L3 interconnect 116 of FIG. 1. In the illustrated embodiment, the read channel 212 and write channel 214 are sixty-four (64) bits wide such that memory reads and writes between the level 2 cache 216 and memory (e.g., memories 118, 120, 146) cause 64-bit blocks of data or instructions to be transferred. Furthermore, cache fills/evictions involving the level 2 cache 216 are performed in four 64-bit bursts at the bus level. However, the scope of this disclosure is not limited to a 64-bit bus and/or the cited size of the bus level data transfer. Other bus sizes and data transfer burst amounts may be used.

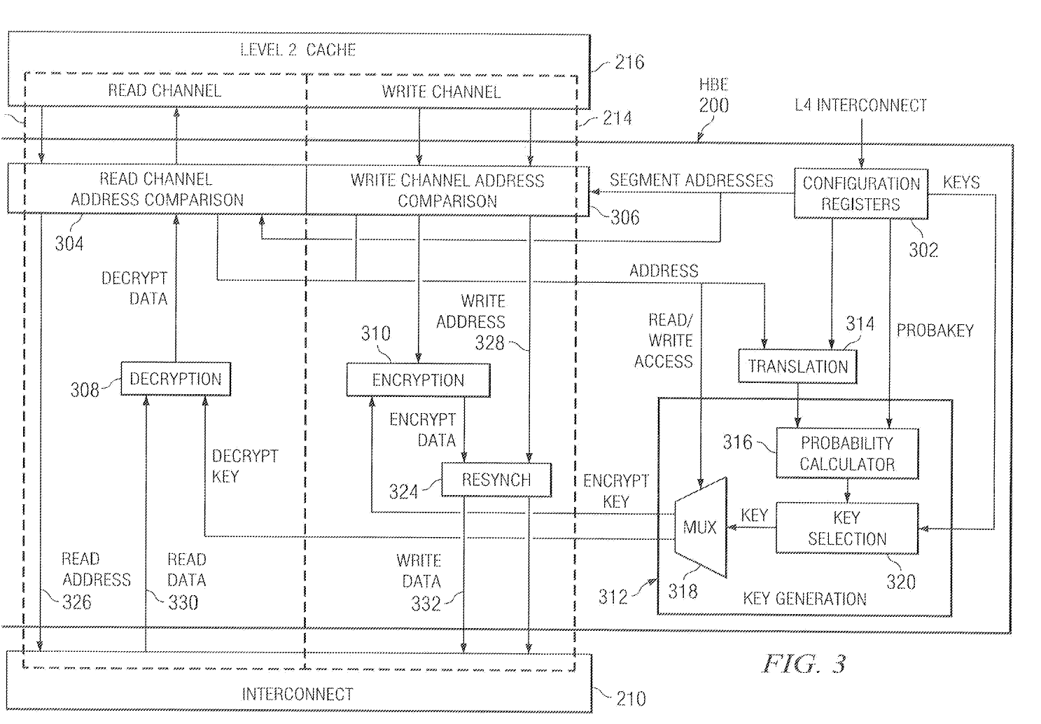

The HBE logic 200 is coupled to the read channel 212 and the write channel 214 such that the HBE logic 200 may intercept memory accesses (i.e., instruction fetches and data reads and writes) between the level 2 cache 216 and memory (e.g., memories 118, 120, 146). The HBE logic 200 may be programmed to monitor the channels for memory accesses within specified address ranges in memory. If the HBE logic 200 detects a memory read of an address within one of these specified address ranges, the HBE logic 200 intercepts the four 64-bit values read starting at that address (i.e., instructions or data) and decrypts the 64-bit values before they are placed in the level 2 cache 216. Similarly, if the HBE logic 200 detects a memory write to an address within one of the specified address ranges, the HBE logic 200 intercepts the four 64-bit values to be written starting at that address and encrypts these values before they are written to memory. Operation of embodiments of the HBE logic 200 is described in more detail below in reference to FIGS. 3-5.

In some embodiments, the system 100 may include software integrity checking (“SIC”) logic 202. As is illustrated in FIG. 2, the SIC logic 202 is coupled to the instruction bus 242 and to the interface bus of the embedded trace macro cell (“ETM”) trace port (not shown) of the MPU 104. The instruction bus 242 is used by the core 110 to fetch instructions for execution from memory, e.g., secure RAM 118. The SIC logic 200 is also coupled to the MPU 104 and the DMA controller 122 by way of the L3 interconnect 116 (not specifically shown). In some embodiments, the SIC logic 200 may be programmed to check the integrity of computer program code executing on the MPU 104. The functionality of embodiments of software integrity checking logic are described in more detail in U.S. patent application Ser. No. 11/463,426, entitled “System and Method for Checking the Integrity of Computer Program Code,” filing date of Aug. 9, 2006 (Attorney Docket No. TI-38800) which is hereby incorporated by reference.

FIG. 3 shows the HBE logic 200 in more detail. The HBE logic 200 includes configuration registers 302, read channel address comparison logic 304, write channel address comparison logic 306, decryption logic 308, encryption logic 310, key generation logic 312, and address translation logic 314. The functionality of the HBE logic 200 is initially explained assuming that some portions of the instructions and data of computer program code (e.g., a software application) executing on the MPU 104 have been previously encrypted using the HBE logic 200 and that these encrypted portions are stored in segments of contiguous memory in external memory 146.

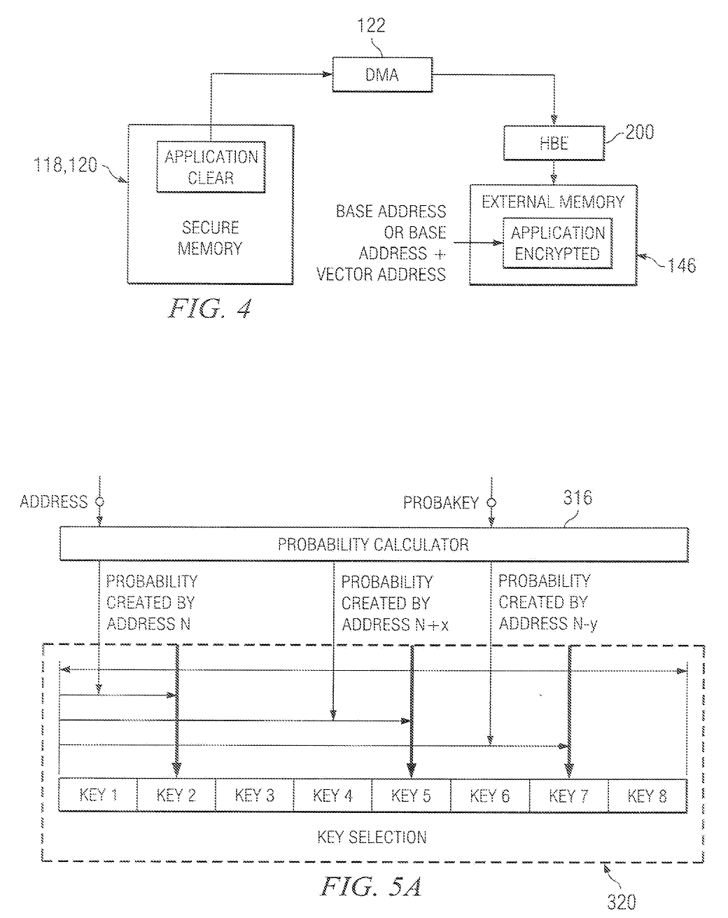

Referring to FIG. 4, the HBE logic 200 may also be used to perform the initial encryption operation as follows: instructions and data of computer program code (e.g., a software application) may be executed to copy instructions/data from secure memory and package them with the executable code of the software that includes the code sequence to create an encrypted code module in external memory 146 for memory management purposes. In some embodiments, a protected code (PC) module includes a PC header, the original start address in memory, the original end address in memory, an address vector for the segment in external memory where the encrypted data will be stored, and a key selection number that is used in encrypting the instructions and data initially, selected based on the segment where the encrypted data will be stored. The PC header may additionally include the address in secure RAM 118 where the code is loaded when it is executed subsequent to its encryption and storage in external memory 146.

Once the protected code module is created, it is compressed and encrypted and stored in storage memory (e.g., external memory 146 or stacked memory 148 of FIG. 1). When the protected code module is to be executed, the operating system of system 100 retrieves the module from storage memory (e.g., external memory 146 or stacked memory 148) and loads it into secure RAM 118. The module 702 is decompressed and/or decrypted by the HBE logic 200 as a part of the retrieval and loading process, as described more fully below.

Referring again to FIG. 3, the configuration registers 302 may be programmed by way of the L4 interconnect 130 and include segment registers and key registers. In some embodiments, the segment registers include register logic to store a start address, an end address, and an address vector for up to three memory address ranges (i.e., segments) in external memory 146. Other embodiments may include register logic in the segment registers 322 for defining more or fewer memory segments.

The start address defines the particular address in the external memory 146 where an encrypted segment starts, and the end address defines the end of the encrypted segment. The address vector defines an offset that may be used by the HBE logic 200 to determine the start and end addresses of the encrypted segment at the time the data and/or instructions in the segment were originally encrypted. As is explained in more detail below, the selection of encryption/decryption keys by the HBE logic 200 may depend on the original addresses of encrypted values at the time they were encrypted. Therefore, if an encrypted segment is relocated to an address range different from the one used when the segment was originally encrypted, the address vector may be programmed with an offset value representing the difference between the original start address and the start address after relocation.

In some embodiments, the key registers include register logic to store up to eight key values and one probability key (“ProbaKey”) value. In other embodiments, the key registers may include register logic to store more or few key values. As is explained in more detail below, the key registers may be programmed before an application is executed with key values and a ProbaKey value that were used to initially encrypt the protected instructions and/or data of the application. The ProbaKey value is used by the HBE logic 200 to select key values from the eight key values to be used for encryption/decryption as the application is executing.

The read channel address comparison logic 304 and the write channel address comparison logic 306 are coupled to the configuration registers 302 to receive segment start and end addresses from the segment registers. The read channel address comparison logic 304 and the write channel address comparison logic 306 monitor respectively, the read channel 212 and the write channel 214 for memory accesses (i.e., read or write operations) directed to address ranges defined in the segment registers. If the address of a read or write operation on the channels 212, 214 is not within one of the address ranges defined the segment registers, the operation is allowed to complete in the absence of further processing by the HBE logic 200. If the address is within one of the defined address ranges, the read channel address comparison logic 304 or the write channel address comparison logic 306 passes the address of the memory access to the translator 314 and sends an indication of whether the memory access is a read or a write operation to the multiplexor (“MUX”) 318 of the key generation logic 310.

The translation logic 314 is coupled to the read channel address comparison logic 304 and write channel address comparison logic 306 to receive an address of a memory access and to the configuration registers 302 to receive address vector values. The translation logic 314 combines the address received from the read channel address comparison logic 304 or the write channel address comparison logic 306 with the address vector value for the address range in which the received address falls to recreate the original address (i.e., the address at which the block of values was stored when originally encrypted.) The translation logic 314 then provides the recreated original address to the probability calculator 316 of the key generation logic 310. In an embodiment, a particular address vector value may be associated with each address range in which the received address may possibly fall, such that the translation logic intelligently selects which address vector value to use for the translation.

The key generation logic 312 provides functionality to select keys from the key values in the key registers to be used for encryption/decryption of the 64 bit values addressed by a memory access falling within one of the memory segments defined in the segment registers. Each key selected by the key generation logic is the same key that was used to originally encrypt each 64-bit value.

The key generation logic 312 includes a probability calculator 316, key selection logic 320, and an encryption/decryption multiplexor (“MUX”) 318. The probability calculator 316 is coupled to the translation logic 314 to receive a translated address and to configuration registers 302 to access the key register containing the ProbaKey value. The probability calculator 316 comprises a linear feedback register (“LFSR”) that uses the Probakey value as a seed to shift the translated address by the ProbaKey value to generate a key selection number.

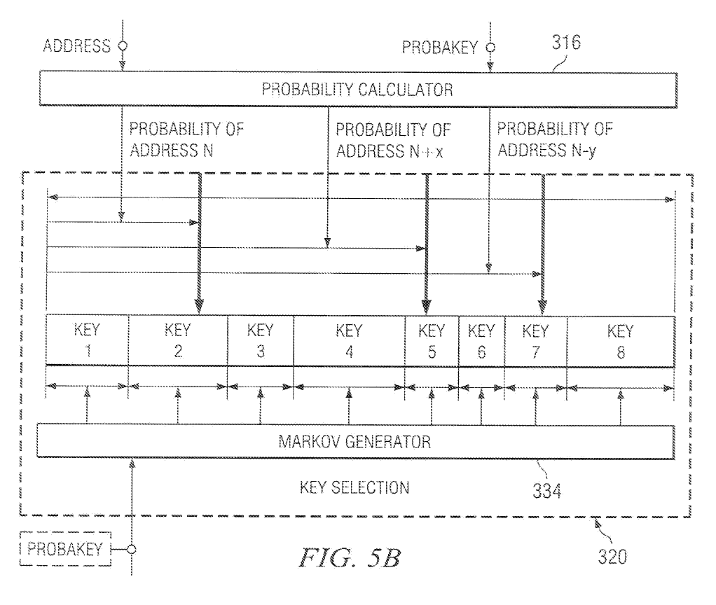

The key selection logic 320 is coupled to the probability calculator 316 to receive the key selection number generated by the probability calculator 316. The key selection logic 320 uses this key selection number to select which of the eight keys to send to the encryption/decryption MUX 318. In some embodiments, the key selection number is a number between 0 and 7 that directly corresponds to one of the eight key registers in the configuration registers 302 (as shown in FIG. 5A). The key selection logic 320 retrieves the key value in the key register corresponding to the number received and passes that key value to the MUX 318.

In other embodiments, a Markov generator 334 uses the Probakey value to randomly assign a numeric range to each key register using (as shown in FIG. 5B). The key selection number may then be a larger number. The key selection logic 320 retrieves the key value in the key register corresponding to the number received and passes the key value to the MUX 318.

The decryption logic 308 couples to the MUX 318, which passes the encryption key selected by the key selection logic 320 and the translated address, and to the external memory 146 via the Interconnect 210. The decryption logic 308 uses the selected encryption key to decrypt the read data 330 stored at the translated address in the external memory 146 according to public and certified crypto-algorithms well known in the art. The decryption logic 308 then returns the decrypted data to the core 110.

The encryption logic 310 couples to the MUX 318, which passes the encryption key selected by the key selection logic 320 and the translated address, and to the external memory 146 via the Interconnect 210. The encryption logic 310 uses the selected encryption key to encrypt the contents to be stored at the translated address in the external memory 146 according to public and certified crypto-algorithms well known in the art. The resynchronization logic 324 couples to the write channel address comparison logic 306, and the encryption logic 310 to combine the target write address 328 from the write operation with the encrypted write data 332 to ensure that the encrypted write data 332 is actually stored in the correct address in external memory.

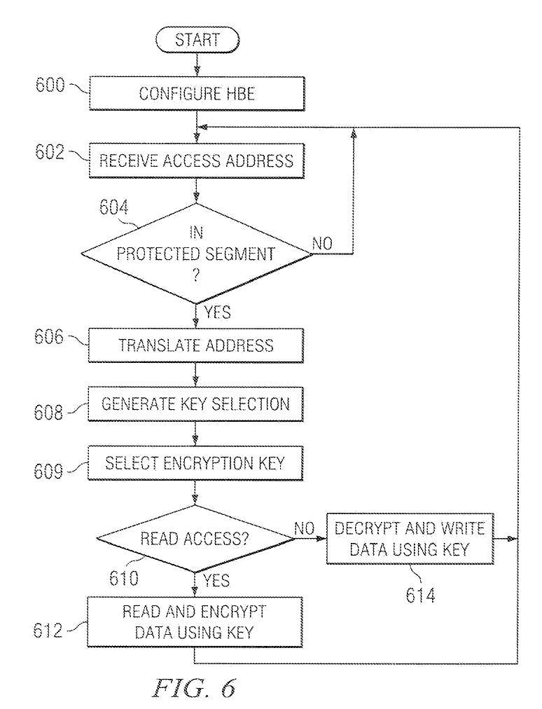

FIG. 6 is a flow chart of a method for protecting data and instructions of computer program code with hardware bus encryption and decryption in accordance with one or more embodiments. Although the actions of this method are presented and described serially, one of ordinary skill in the art will appreciate that the order may differ and/or some of the actions may occur in parallel. The method begins with configuring the HBE logic 200 (block 600). Configuring the HBE logic 200 may include loading a plurality of encryption keys and an address range configuration associated with a segment of external memory 146 (i.e., a range of physical addresses of an external memory 146). Once configured with the encryption keys and address range configuration, the HBE logic 200 is operable to monitor the read and write channels 212, 214 for memory accesses within specified address ranges in external memory 146.

The HBE logic 200 receives a memory access address at block 602. Specifically, if the memory access is a read, the read channel address comparison logic 304 receives the memory access address on the read channel 212, while if the memory access is a write, the write channel address comparison logic 306 receives the memory access address on the write channel 214.

At 604, the HBE logic 200 determines whether the memory access address received is in a protected segment of external memory (block 604). Specifically, the segment addresses from the configuration registers 302 enable the read channel address comparison logic 304 or the write channel address comparison logic 306 (depending on whether a read or a write operation) to determine whether the specific memory access address falls within one of the segment addresses.

If the memory access address is not within one of the defined address ranges, the access operation is permitted to continue in the absence of any further processing by the HBE logic 200, and the process returns to monitoring the read channel 212 and write channel 214 for memory accesses. If the memory access address is within one of the defined address ranges, the read channel address comparison logic 304 or the write channel address comparison logic 306 passes the address of the memory access to the translation logic 314, and sends an indication of whether the memory access is a read operation or a write operation to the MUX 318.

At block 606, the translation logic 314 translates the memory access address (block 606) by combining the address received (from the read channel address comparison logic 304 if a read operation or the write channel address comparison logic 306 if a write operation) with the address vector value for the defined address range in which the received address falls. By doing so, the translation logic 314 recreates the original address at which the block of values was stored when originally encrypted. The translation logic 314 then passes the translated address to the probability calculator 316. The probability calculator 316 uses the Probakey value as a seed to shift the translated address, thereby generating a key selection number (block 608). The key selection number is used by the key selection logic 320 to select which of the encryption/decryption keys to send to the MUX 318 (block 609).

The HBE logic 200 determines whether the memory access is a read access operation (block 610). If so, the MUX 318 passes the encryption key and the translated address to the encryption logic 310, which reads and encrypts the data at the translated address using the selected encryption key (block 612). The encryption may also include a resynchronization step when the write address generated at the translation logic 314 and the encrypted data generated at the encryption logic 312 are combined such that the correct encrypted data is actually stored in external memory at the correct address. If at block 610, the memory access is a write operation, not a read access, then the MUX 318 passes the decryption key and the translated address to the decryption logic 308, which reads and decrypts the data at the translated address using the selected encryption key (block 614), and returns the decrypted data to the bus.

The above discussion is meant to be illustrative of the principles and various embodiments of the present invention. Numerous variations and modifications will become apparent to those skilled in the art once the above disclosure is fully appreciated. For example, the scope of disclosure is not limited to any particular number of cores or caches. Any number of cores and/or caches may be used. It is intended that the following claims be interpreted to embrace all such variations and modifications.

1. A method for protecting data and instructions of computer program code, the method comprising:
receiving a memory access request from a processor, the memory access request comprising a physical address of a memory location;
generating an output value with a pseudo random number generator based on the physical address;
non-deterministically selecting an encryption key from a plurality of encryption keys using the output value;
if the memory access request is a read operation, decrypting the contents of the memory location using the selected key and providing the decrypted contents to the processor; and
if the memory access request is a write operation, encrypting a value from the memory access request using the selected key and writing the encrypted value to the memory location.

2. The method of claim 1, wherein generating an output value with a pseudo random number generator based on the physical address comprises shifting the physical address by a seed vector value, and providing the shifted result and a seed value to the pseudo random number generator to produce the output value.

3. The method of claim 1, further comprising configuring a hardware bus encryption logic by loading the plurality of encryption keys and an address range configuration associated with a range of physical addresses of an external memory.

4. The method of claim 3, further comprising determining if the physical address of the memory location falls in the address range configuration associated with physical address of the external memory.

5. The method of claim 3, wherein receiving the memory access request is performed by the hardware bus encryption logic between the processor and the external memory.

6. The method of claim 2, wherein generating an output value with a pseudo random number generator based on the physical address further comprises translating the physical address by combining the physical address with the particular vector value indicating an address range in which the physical address falls, thereby recreating the address in memory where the content was stored when originally encrypted.

7. The method of claim 1, wherein the selected encryption key is the same key used to originally encrypt the content of the memory location.

8. A system comprising:
a processor coupled to a plurality of busses;
an external memory coupled to the plurality of busses, wherein the external memory is accessible by the processor;
a hardware encryption (HBE) logic coupled to the plurality of busses, wherein the HBE logic receives a memory access request from the processor on one of the plurality of busses, the memory access request comprising a physical address of a memory location;
wherein the HBE logic is operable to generate a random output value based on the physical address; and non-deterministically select an encryption key from a plurality of encryption keys using the output value;
if the memory access request is a read operation, the HBE logic decrypts the contents of the memory location using the selected key and provides the decrypted contents to the processor; and
if the memory access request is a write operation, the HBE logic encrypts a value from the memory access request using the selected key and writes the encrypted value in the memory location.

9. The system of claim 8, further comprising an interface to a programming interface operable to configure the HBE logic by loading the plurality of encryption keys and an address range configuration associated with a range of physical addresses of an external memory.

10. The system of claim 8, wherein the HBE logic further determines if the physical address of the memory location falls in the address range configuration associated with physical address of the external memory.

11. The system of claim 8, wherein the HBE logic further translates the physical address by shifting the physical address by a vector value associated with the address range in which the physical address falls, thereby recreating the physical address in the memory location wherein the content was stored when originally encrypted.

12. The system of claim 8, wherein the HBE logic generates an output value with a pseudo random number generator based on the translated physical address and a seed value; and non-deterministically select an encryption key from a plurality of encryption keys using the output value;

13. The system of claim 8, wherein the system is a mobile device.

14. A hardware bus encryption (HBE) apparatus, comprising:
a means for receiving a memory access request, wherein the memory access request comprises a physical address of a memory location;
a configuration register coupled to the means for receiving a memory access request, wherein the configuration register stores a plurality of encryption keys and at least one address range having an address vector;
a translation logic coupled to the means for receiving a memory access request and the configuration register, wherein the translation logic combines the physical address of the memory location with the address vector to result in a translated address;
a key generation logic coupled to the translation logic and the configuration register, wherein the key generation logic generates a key selection output based on the translated address, and selects an encryption key from the plurality of encryption keys;
a encryption/decryption logic coupled to the key generation logic, wherein the encryption/decryption logic receives the selected encryption key from the key generation logic, and encrypts or decrypts the contents stored at the physical address using the encryption key.

15. The HBE apparatus of claim 14, wherein the means for receiving the memory access request comprises a channel address comparison logic that monitors an incoming channel for the memory access request and determines whether the memory access request is a read operation or a write operation.

16. The HBE apparatus of claim 14, wherein the configuration register further stores a seed value and the key generation logic generates a key selection output based on the translated address and the seed value.

17. The HBE apparatus of claim 16, wherein the key generation logic comprises:
a probability calculator coupled to the translation logic, wherein the probability calculator comprises a linear feedback register to shift the translated address by the seed value to generate a key selection number;
a key selection logic coupled to the probability calculator, wherein the key selection logic selects one the plurality of encryption keys from the configuration register using the key selection number and forwards the selected encryption key to an encryption/decryption multiplexor (MUX); and
the encryption/decryption MUX coupled to the encryption/decryption logic and the channel address comparison logic, wherein the encryption/decryption MUX indicates to the encryption/decryption logic 1) whether to perform an encryption in the case of a write operation or a decryption in the case of a read operation and 2) the encryption key to use in either encryption or decryption.

18. The HBE apparatus of claim 17, wherein the probability calculator further comprises a Markov generator to create a unique dispersion of usage probability of each encryption key among the plurality of encryption keys.

19. The HBE apparatus of claim 14, wherein the memory access request comprises a read operation or a write operation to a location in external memory.

20. The HBE apparatus of claim 14, further comprising a resynchronization logic that combines the translated address with the encrypted contents, thereby ensuring that the contents are stored at the translated address in external memory.
